(19) United States
(12) Patent Application Publication
(10) Pub. No.: US 2022/0300653 A1
(43) Pub. Date: Sep. 22, 2022

(54) SYSTEMS, MEDIA, AND METHODS FOR IDENTIFYING, DETERMINING, MEASURING, SCORING, AND/OR PREDICTING ONE OR MORE DATA PRIVACY ISSUES AND/OR REMEDIATING THE ONE OR MORE DATA PRIVACY ISSUES

(71) Applicant: Zen Privata, Inc., Acton, MA (US)

(72) Inventors: George Wrenn, Acton, MA (US); Scott Schlimmer, St. Petersburg, FL (US)

(21) Appl. No.: 17/697,271

(22) Filed: Mar. 17, 2022

Related U.S. Application Data
(60) Provisional application No. 63/162,862, filed on Mar. 18, 2021.

(51) Int. Cl. G06F 21/62; G06F 21/57; G06F 21/60

(52) U.S. Cl. CPC G06F 21/6263; G06F 21/577; G06F 21/606; G06F 2221/034

(57) ABSTRACT

In an embodiment, sources may be scanned to obtain and classify client data. The classified client data may be required to or encouraged to satisfy a privacy rule/regulation. In an embodiment, a geographic privacy posture may be determined for the client data, where the geographic privacy posture may represent an indication as to whether the client data is or may potentially be susceptible/vulnerable to risk, e.g., privacy risk, based on one or more of the factors. If the client data is or may potentially be susceptible/vulnerable to privacy risk, the geographic privacy posture may also indicate or quantify, based on the one or more factors, a level of the privacy risk. Based on the determined geographic privacy posture, the one or more embodiments described herein may determine one or more protective custodial measures that can be implemented such that privacy protection of the client data improves.

### CROSS-REFERENCE TO RELATED APPLICATIONS

The present application claims the benefit of U.S. Provisional Patent Application Ser. No. 63/162,862, which was filed on Mar. 18, 2021, by George Wrenn et al. for SYSTEMS, MEDIA, AND METHODS FOR IDENTIFYING, DETERMINING, MEASURING, SCORING, AND/OR PREDICTING ONE OR MORE DATA PRIVACY ISSUES AND/OR REMEDIATING THE ONE OR MORE DATA PRIVACY ISSUES, which is hereby incorporated by reference.

### BRIEF DESCRIPTION OF THE DRAWINGS

The description below refers to the accompanying drawings, of which:

FIG. 1 is a high-level block diagram of an example architecture for identifying, determining, and/or predicting one or more privacy issues for data (i.e., client data) and/or remediating the one or more privacy issues according to one or more embodiments described herein;

FIG. 2 is a schematic illustration of a flow diagram of an example method for scanning one or more sources associated with a data custodian to obtain and classify client data according to one or more embodiments described herein;

FIG. 3 is a schematic illustration of a flow diagram of an example method for determining a geographic privacy posture for the client data such that one or more protective custodial measures can be implemented according to one or more embodiments described herein; and

FIG. 4 is a schematic illustration of a flow diagram of an example method for determining an affiliate risk for an affiliate of a data custodian according to one or more embodiments described herein.

### DETAILED DESCRIPTION OF AN ILLUSTRATIVE EMBODIMENT

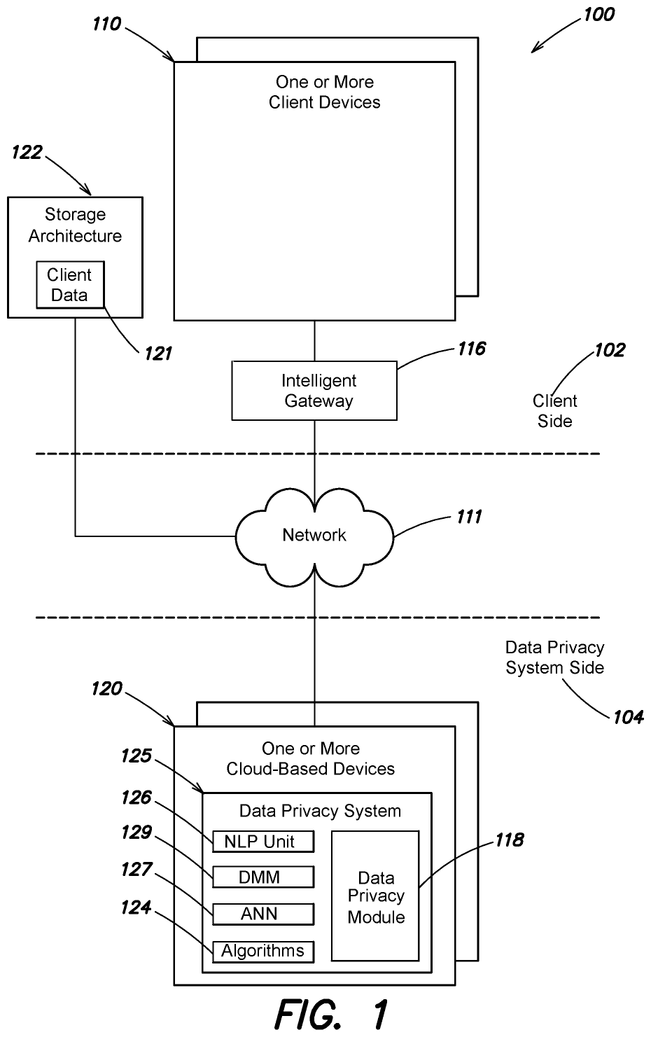

FIG. 1 is a high-level block diagram of an example architecture 100 for identifying, determining, and/or predicting one or more privacy issues for data (i.e., client data) and/or remediating the one or more privacy issues according to one or more embodiments described herein. The architecture 100 may be divided into a client side 102 that includes one or more local client devices 110 that are local to an end-user, and a data privacy system side 104 that includes one or more cloud-based devices 120 that are remote from the end-user and that are accessible to the end-user via a network 111 (e.g., the Internet). Each computing device, e.g., one or more local client devices 110 and one or more cloud-based devices 120, may include processors, memory/storage, a display screen, and other hardware (not shown) for executing software, storing data and/or displaying information.

A local client device 110 may provide a variety of user interfaces and non-processing intensive functions. For example, a local client device 110 may provide a user interface, e.g., a graphical user interface and/or a command line interface, for receiving user input and displaying output according to the one or more embodiments described herein. An intelligent gateway 116 may coordinate operation of the one or more local client devices 110 and the one or more cloud-based devices 120 such that, for example, the one or more local client devices 110 may communicate with and access data privacy system 125 stored on the one or more cloud-based client devices 120 via network 111. In an embodiment, the intelligent gateway 116 allows for “agentless” interaction with the data privacy system 125, in which end users can interact with the client devices 110, and vice-versa, seamlessly and without having to install any particular “agents” on either side (e.g., on the client side 102 and/or the data privacy side 104).

The storage architecture 122 can be any of a variety of different types of storage that may store the client data 121. For example, the storage architecture 122 may include, but is not limited to, cloud storage, databases, applications, APIs, the Internet of Things (IoT) storage, hard disk drives, solid state drives, etc. The client data 121 stored on the storage architecture 122 may, for example, include sensitive information of a class that is protected/regulated (e.g., regulated by law, standards, regulations, treatises, or organizational requirements, etc.). For example, the sensitive information may include, but is not limited to, personal identification information (name, address, Social Security information, credit card information, etc.), medical information, etc. As such, and to protect the client data 121 from non-authorized users (e.g., users not affiliated with the client devices 110 that manage the client data 121) and/or non-authorized purposes, one or more privacy algorithms (e.g., anonymization, tokenization, encryption algorithm, blockchain entry/item, sharding, etc.) and/or artificial intelligence (“AI”) techniques may be implemented to protect the client data, e.g., protect the privacy of the client data 121 such that it cannot be obtained, can be obtained but cannot be recognized and/or deciphered, and/or utilized by non-authorized end users and/or identify an individual.

The or one or more cloud-based devices 120 may store data and execute actions on data stored in data privacy system 125 that may implement the one or more embodiments described herein. In an implementation, the data privacy system 125 is an application, i.e., software. The data privacy system 125 may include a data privacy module 118 that may utilize algorithms 124 and/or models 129 (e.g., data management model (DMM)) to implement the one or more embodiments describe herein and as described in further detail below. More specifically, the data privacy module 118 may access client data 121 that may include sensitive information and identify, determine, and/or predict one or more privacy issues associated with the data utilizing algorithms 124 and/or DMM 129 according to the one or more embodiments described herein and as described in further detail below.

For example, the data privacy module 118 may determine a “privacy posture” for the client data 121, wherein the privacy posture may provide a metric or indication regarding the privacy strength or weakness of the client data 121. In addition or alternatively, the data privacy module 118 may remediate the one or more determined or predicted privacy issues according to the one or more embodiments described herein and as will described in further detail below.

Further, the data privacy system 125 may include a natural language processing (NLP) unit 126 and an artificial intelligence neural network(s) (ANN) 127 that may flag extracted keywords (e.g., client data 121) and classify and label the flagged keywords as described in further detail below. In addition, or alternatively, other AI based techniques (including algorithms) may be utilized to flag extracted keywords (e.g., client data 121), label, and/or classify the flagged keywords as described herein. For example, one or more suitable neural networks, e.g., convolutional neural networks (“CNNs”), recurrent neural networks (“RNNs”), autoencoders, etc., can be used for classification of and/or labeling of keywords. As such, the described examples are for illustrative purposes only, and it should be understood that different types of artificial intelligence techniques may be utilized with the one or more embodiments described herein.

In some embodiments, one or more of the data privacy system 125, data privacy module 118, algorithms 124, models 129, NLP unit 126, and ANN 127 may be implemented through one or more software modules, API calls, or libraries containing program instructions that perform the methods described herein, among other methods. The software modules may be stored in one or more memories, such as a main memory, a persistent memory, and/or a computer readable media, of a data processing device, and may be executed by one or more processors. Other computer readable media may also be used to store and execute these program instructions, such as one or more non-transitory computer readable media, including optical, magnetic, or magneto-optical media.

In other embodiments, one or more of the data privacy system 125, data privacy module 118, algorithms 124, models 129, NLP unit 126, and ANN 127 may be implemented in hardware, for example through hardware registers and combinational logic configured and arranged to produce sequential logic circuits that implement the methods described herein. In other embodiments, various combinations of software and hardware, including firmware, may be utilized to implement the systems and methods of the present disclosure.

In an implementation, client data 121 may be any data associated with an individual, multiple individuals, and/an entity (e.g., company, corporation, etc.), where the client data 121 may be sensitive information that is required to or encouraged to satisfy one or more privacy rules/regulations or best practices, based on at least geography and IP address block assignment (IANA et al.), as will be described in further detail below.

In an implementation, and as described herein, the individual, multiple individuals, and/or entity that is related to the client data 121 may be referred to as a “principal” of the client data 121 (i.e., the client data 121 includes information (e.g., identifying information) relating to the principal). For example, if the client data 121 includes an individual's name and his/her credit card information, the individual may be referred to as the principal of the client data 121. In an implementation, and as described herein, an individual, multiple individuals, or entity that has the responsibility to store (e.g., electronically store) the client data 121 and/or has privacy obligations for the client data 121 may be referred to as a “data custodian” of the client data 121. For example, if a credit card company stores the client data 121 that includes the individual's name and his/her credit card information, the credit card company may be referred to as the data custodian of the client data 121.

As another example, a hospital may store patient medical records for a plurality of different patients. As such, and in this example, the hospital may be the data custodian of the patient medical records while each of the patients may be a different principal for his/her patient medical records (or a parent may be a principal of his/her child's (e.g., under 18) medical records). As a different example, an entity such as a cloud storage service provider may be a data custodian of client data 121 for a plurality of different “customers” that may be principals of their client data 121. As such, the cloud storage service provider may store different types of client data, in different systems or via API call to the remote system 121, for the different customers at different locations. The different client data 121 at different locations may be required to or encouraged to satisfy different privacy rules/regulations based on at least geography as will be described in further detail below.

The examples as described herein are for illustrative purposes only, and it is expressly contemplated that the data custodian of the client data 121 and the principal of the client data 121 may be the same or different individuals, entities, etc. As such, client data 121 as described herein is to broadly cover any type of data, where the client data 121 may have to satisfy or may be encouraged to satisfy one or more privacy rules/regulations or other rules/regulations based on a variety of factors such as, but not limited to, types of data, geography, etc. In an embodiment, the privacy rules/regulations may describe the way in which electronic data is to be stored such that the client data 121 is not accessible, recognizable, or cannot be utilized by unauthorized individuals, entities, etc.

In an implementation, there may be a different DMM 129 for each data custodian that is responsible for the client data 121, e.g., the data custodian is responsible to ensure that the client data 121 adheres to all applicable laws/regulation and/or that the client data 121 is not accessible and recognizable by non-authorized users and not utilized for non-authorized purposes. In an embodiment, the DMM 129 for a data custodian may store information associated with the client data 121 (e.g., a type of the client data), data custodian information that describes the data custodian of the client data 121, principal information that describes the principle that is related to the client data 121, etc. as will be described in further detail below.

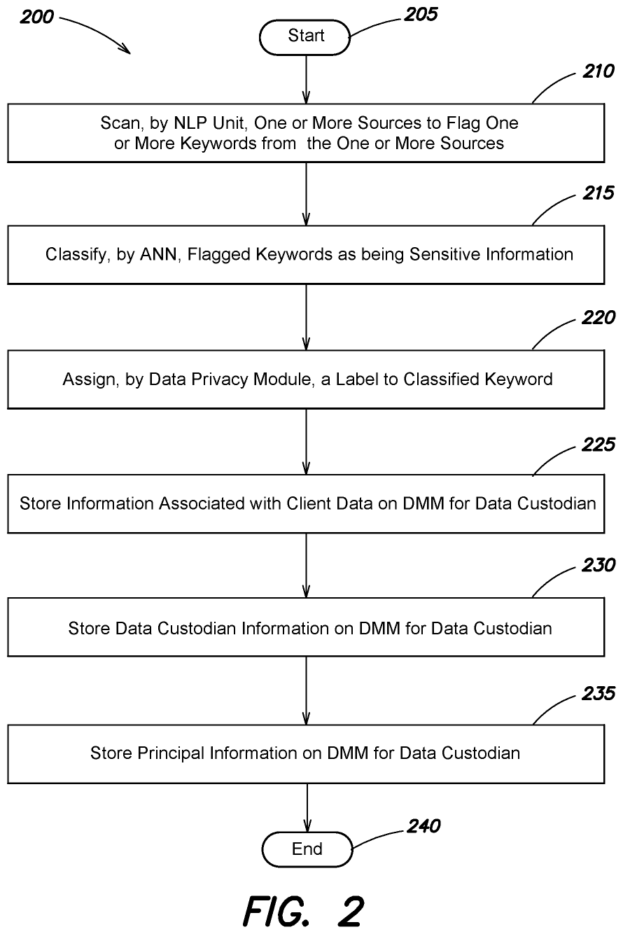

FIG. 2 is a schematic illustration of a flow diagram of an example method for scanning one or more sources associated with a data custodian to obtain and classify client data 121 according to one or more embodiments described herein. As described herein, the data privacy system 125 may include NLP unit 126 and ANN 127 that provide for capabilities to flag (e.g., identify and extract) and classify keywords (e.g., client data 121) that are extracted from one or more sources. In an embodiment, the one or more sources may include, but are not limited to, websites, applications, datastores, etc. that may be associated with the data custodian.

The procedure 200 starts at step 205 and continues to step 210 where the NLP unit 126 of the data privacy module 118 scans one or more sources to flag one or more keywords (e.g., words, number, any character, string of characters, etc.) from the sources. For example, the NLP unit 126 may scan a data source (e.g., data store, website, etc.) associated with a data custodian to identify and extract one or more keywords associated with the client data 121. Specifically, the NLP unit 126 may utilize one or more rules to flag an extracted keyword. For example, a rule may indicate that an extracted keyword should be “flagged” as potentially including sensitive information that is of a class that is protected/regulated (e.g., Social Security number) if the extracted keyword includes at least 9 consecutive characters (e.g., letter, number, space, punctuation mark, or symbol). The single rule as described herein is for illustrative purposes only, and it is expressly contemplated that the NLP unit 126 may use many and a variety of different rules, which may be complex to flag extracted keywords according to the one or more embodiments described herein. If, for example, the extracted keyword does not meet or satisfy the criteria of the rules, the NLP unit 126 may determine that the extracted keyword should not be flagged and is non-sensitive or of a class that is to be protected/regulated, and the information can be discarded.

In addition, and according to the one or more embodiments described herein, the NLP unit 126 may include linguistic expansion capabilities such that additional keywords that do not exactly satisfy the criteria of the one or more rules may also be “flagged.” For example, the NLP unit 126 may include linguistic expansion capabilities such that keywords that are not at least 9 consecutive characters may still be flagged. For example, and based on a rule/regulation being modified in a region, a personal identification number (e.g., Social Security number) may be modified to, for example, be 8 consecutive numbers instead of 9 consecutive numbers. As such, the NLP unit 126 may be adaptive with linguistic expansion capabilities such that additional keywords can be flagged even when a rule is not satisfied according to the one or more embodiments described herein.

The linguistic expansion capabilities of the NLP unit 126 may also identify/extract a keyword (e.g., last 4 of an SSN) based on a rule and may identify/extract a different keyword based on a different rule (e.g., last name). The rules may be structured in a hierarchy or other schema such that the NLP unit 126 may determine that although the extracted keywords by themselves provide little privacy risk, the extracted keywords are significant in terms of privacy risk when concatenated or interpreted together. For example, the last 4 numbers of an SSN may by itself provide little privacy risk. However, when the last 4 numbers of the SSN are interpreted or utilized in conjunction with a corresponding last name, the two portions of information may be utilized for unauthorized purposes. Additionally, linguistic expansion capabilities of the NLP unit 126 to identify keyword related to extracted keywords. For example, if an extracted keyword “Cornhuskers”. The linguistic expansion capabilities may identify related words such as, but not limited to, Nebraska, football, NCAA, Big Ten, etc. As such, the linguist expansion capabilities of the NLP unit 126 may extract keywords that together may be flagged.

In addition, or alternatively, the NLP unit 126 may identify and extract one or more similar/additional keywords that are related to an identified keyword (e.g., by being synonymous, antonymous, etc.). As an example, in an implementation, the NLP unit 126 may, as part of the linguistic expansion capabilities, identify synonyms of an identified keyword such that related keywords can be flagged. Here, the word hemoglobin may be expanded to “flag” keywords related to blood, protected health information, etc. Accordingly, deviations from or deviations of the keywords that are flagged utilizing the rules, may also be flagged based on the linguistic expansion capabilities of the NLP unit 126.

At step 215, and after extracted keywords are flagged utilizing the NLP unit 126, the flagged keyword may be classified, using ANN 127, as being sensitive information. In the example where the flagged keyword is at least 9 consecutive characters, the flagged keyword may be provided to ANN 127 such that the flagged keyword can be classified according to the one or more embodiments described herein.

Specifically, the ANN 127 may include a plurality of nodes and utilize a probability (e.g., Bayesian or other) distribution technique to classify the flagged keywords. Each node of the ANN 127 may be utilized to perform a computation such that the flagged keyword, extracted and flagged based on the NLP unit 126 as described above, can be classified as being sensitive information. Continuing with the above example where the flagged keywork is at least 9 consecutive characters, the ANN 127 may, for example, be utilized to classify the flagged keywork as a U.S. Social Security number, a National Insurance number utilized in the United Kingdom, or a date of birth. Specifically, a U.S. Social Security number may be defined as (1) nine consecutive number (e.g., 1112222333), or (2) three consecutive numbers, followed by a hyphen, followed by four consecutive numbers, followed by a hyphen, and followed by three consecutive numbers (e.g., 111-2222-333). Additionally, a National Insurance number utilized in the United Kingdom (UK) may be defined as two prefix letters, followed by six consecutive numbers, followed by one suffix letter (e.g., AA123456C). Further, a date of birth may be defined as two consecutive numbers, followed by a forward slash, followed by two consecutive numbers, followed by a forward slash, followed by four consecutive numbers (e.g., 01/02/1902).

Therefore, and in this example, the nodes of the ANN 127 may utilize the defining characteristics (defining characteristics of the U.S. Social Security number, the National Insurance number utilized in the UK, and the date of birth as described above) to perform one or more computations on or for the flagged data to classify the flagged keyword as one of U.S. Social Security number, a National Insurance number utilized in the United Kingdom, or a date of birth according to the one or more embodiments described herein. In an embodiment, the classification determined by the ANN 127 for the flagged keyworded may be based on a statistical probability.

The example as described herein is for illustratively purposes only, and it is expressly contemplated that the ANN 127 may classify any flag keyword as being sensitive information utilizing statistical probabilities. As such, it should be understood that the ANN 127 may be complex and learning (i.e., machine learning) to classify and flag keywords.

Additionally, the results of the classification utilizing the ANN 127 may result in the generation of a heat map that may provide an indication of the risk, e.g., privacy risk, associated with the classified item(s). For example, the data privacy module 118 may determine that a classified Social Security number has a higher associated risk than a different classified item, e.g., first name of “John”. For example, the data privacy module 118 may assign a severity score to classified client data based on a sensitivity of the classified client data and/or to indicate the potential severity of harm that may be caused if the classified client data were compromised for unauthorized purposes. As such, and in this example, the classified Social Security may have a higher severity score than the classified first name since a Social Security number is more sensitive, in terms of privacy and/security, than a first name of a person. For example, and based on the potential privacy risk, the data privacy module may assign as score from a scale where a first end of the scale indicates little privacy risk while a second end of the scale indicates high privacy risk. Accordingly, a user may utilize the heat map with the assigned scores to understand which client data is susceptible to the most severe privacy risk.

In addition, and based on the classification, monetary values may be assigned that indicate penalties that may be incurred if the classified keywork is “not” anonymized or protected, as required. As such, and by generating the heat map, the data privacy module 118 may quantify the level of risk for each of the classified keywords (e.g., client data 121) and also provide a relationship among the risk of all the classified keywords (e.g., client data 121). The heat map may be provided by the data privacy module 118 to a client device 110 being operated by the data custodian such that the data custodian can understand which pieces (e.g., keywords) of the client data 121, for which the data custodian is responsible, is most/least susceptible to current and/or future privacy risk, and/or the monetary values associated with the privacy risk. As a result, the user (e.g., data custodian) can understand its client data 121 from a privacy/rules/regulations perspective according to the one or more embodiments described. Advantageously, the data custodian can make changes regarding its management of the client data (e.g., implement a most stringent encryption algorithm, etc.) to avoid the privacy risk and/or negative monetary implications of not protecting the client data 121. In addition, the monetary values may be determined for each of the different changes to be made for the management of the client data (e.g., moving the data, encrypting the data, etc.) and provided, e.g., displayed, to the user. Advantageously, a data custodian can utilize the determined monetary values to determine and/prioritize, which of the different changes to implement and in which order to maximize return on investment (ROI) and other financial concepts of any privacy action taken or changes to the DMM and scoring.

In response to the classification, the procedure continues to step 220 and the data privacy module 118 (e.g., the ANN 127 of the data privacy module 118) assigns a label to the classified keyword. For example, a label of “US SSN” may be assigned to a keyword, extracted based on the NLP unit 126 and classified based on a statistical probability by the ANN 127, as being a U.S. Social Security number. Advantageously, and as will be described in further detail below, a privacy posture for the classified and labeled keywords (e.g., client data 121) may be determined according to the one or more embodiments described herein. In an implementation, the label assigned to a classified keyword may dictate which one or more protective custodial measures should be implemented such that privacy protection of the client data 121 improves. For example, and when the label of “US SSN” is assigned, the data privacy module 118 may one or more predetermined protective custodial measure that are to be used for U.S. Social Security numbers. In an embodiment, the one or more predetermined custodia measures are determined/identified by the data custodian.

In an embodiment, the ANN 127 may include back feeding (BF-ANN) capabilities. The back feeding capabilities may be utilized, according to the one or more embodiments described herein, for increasing statistical probabilities for classifying the flagged keywords. For example, and continuing with example above, the National Insurance number utilized in the UK starts with a prefix of two consecutive letters. By back feeding the ANN 127 with results that classify particular keywords as National Insurance numbers utilized in the UK, the ANN 127 may “learn” that flagged keywords with a prefix of two consecutive letters that does not include a particular letter (e.g., D, F, I, Q, U or V) are highly likely (e.g., statistical probability of 95%) to be a National Insurance number utilized in the UK. Similarly, by back feeding the ANN 127 with the results that classify particular keywords as National Insurance numbers utilized in the UK, the ANN 127 may also “learn” that flagged keywords with a prefix of two consecutive letter that include the particular letter (e.g., D, F, I, Q, U or V) are highly unlikely (e.g. statistical probability of 95%) to be a National Insurance number utilized in the UK. As such, the ANN 127 may utilize back feeding to improve the statistical probabilities for determining the results of its classifications according to the one or more embodiments described herein.

The procedure continues to step 225 and the data privacy module 118 stores information associated with the client data 121 on the DMM 129 for the data custodian. Continuing with the example above of the hospital as the data custodian, let it be assumed that the classified and labeled “US SSN” as described above is part of the client data 121 for which the hospital is the data custodian. As such, the “US SSN” label may be stored in the DMM 129 for the hospital to indicate that the hospital is storing a “US SSN” that was readily obtained via the scan, and the obtained “US SSN” may need to be protected. In addition, the DMM 129 may indicate that the hospital is the data custodian for patient medical records.

The DMM 129 may also store data custodian information for the data custodian of the client data 121. Specifically, the procedure of FIG. 2 continues to step 230 and the data privacy module 118 stores data custodian information on the DMM 129 for the data custodian. In an implementation, the data custodian information may include, but is not limited to, where the client data 121 is stored, primary/secondary/tertiary business locations for the user/entity that is the data custodian, the techniques/algorithms utilized to protect the privacy of the client data 121, identifying information identifying the principals of the client data that the data custodian is responsible for, etc.

Continuing with the example where the hospital is the entity that is the data custodian of the patient medical records, the data custodian information stored on DMM 129 may indicate that patient medical records for one or more principals, e.g., John Doe, are stored in Massachusetts (e.g., on storage devices in Massachusetts) while patient medical records for one or more principals, e.g., Jane Doe, are stored on in California (e.g., on storage devices in California). In addition, or alternatively, the data custodian information stored on DMM 129 may indicate one or more anonymization, tokenization, masking, or encryption algorithms or techniques utilized to protect the privacy of the client data 121. For example, the data custodian information may indicate that the patient medical records (e.g., stored in Massachusetts and California) are encrypted utilizing a single level encryption algorithm.

In an embodiment, the data custodian may provide the data custodian information to the data privacy system 125 through use of the client device 110 such that the data custodian information is stored on DMM 129. In an alternative embodiment, the data custodian information may be “pushed” to the data privacy system 125 or “pulled” from the client device 110 to the data privacy system 125 such that the data custodian information is stored on DMM 129. For example, the data privacy module 118, through the intelligent gateway 116, may scan the one or more cloud-based devices 120 and/or local premises, such as primary, secondary, and tertiary premises (not shown) of the data custodian to identify and label the data custodian information in a similar manner as described above with reference to FIG. 2. More Specifically, the intelligent gateway 116 provides a secure tunnel that allows the data privacy module 118 to access the one or more cloud-based device 120 and or local premises of the data custodian to obtain the data custodian information, where the data privacy module 118 may utilize labels to “tag” the obtained data custodian information for later identification.

Additionally, the DMM 129 for the data custodian may store metadata and other information associated with the principal of the client data 121. Specifically, the procedure of FIG. 2 continues to step 235 and the data privacy module 118 stores principal information on the DMM 129 for the data custodian. In an implementation, the metadata and/or other information associated with the principal of the client data 121 may be referred to as “principal information.” For example, each principal of client data 121 may register with the data privacy system 125 in a conventional manner to setup a unique data privacy system account. As part of registration process, or independent of the registration process, the principal may utilize a client device 110 (e.g., mobile device) to provide the principal information to the data privacy system 125 such that the principal data is stored on DMM 129 for the data custodian. The principal information may include, but is not limited to, the name, address, date of birth, nationality, age, etc. of the principal or may include other information such as, but not limited to, citizenship, data custodians of the principal's client data, etc.

Continuing with the hospital example, let it be assumed that John Doe is a principal registered with the data privacy system 125 and the DMM 129 stores principal information that indicates that John Doe is a resident of Boston, Mass. and his citizenship is the United States. Additionally, let it be assumed that Jane Doe is a principal registered with the data privacy system 125 and the DMM 129 stores principal information that indicates that Jane Doe is a resident of San Francisco, Calif. and her citizenship is Germany.

It is noted that the information associated with the client data 121 and other information, e.g., the data custodian information and principal information, stored on the DMM 129 may be updated at one or more different times automatically or based on user input and, as such, the DMM 129 may be dynamic. For example, if a principal moves to a new residence or acquires new citizenship, the principal information may be updated to reflect such changes. The DMM 129 provides a link between the data custodian of the client data 121 and the principal of the client data 121 in which the principal can update or delete their information, after identity verification, without intervention from the client. The information associated with the client data 121, the data custodian information, and the principal information stored on the DMM 129 may be anonymized or cryptographically protected utilizing, for example, one or more blockchain cryptographic algorithms. In addition or alternatively, the data custodian information may also be verifiable utilizing, for example, blockchain, or other secure distributed ledger system. The procedure then ends at step 240.

According to the one or more embodiments described herein, the client data 121 (that may be obtained and classified as described with reference to FIG. 2) may be required to or encouraged to satisfy a privacy rule/regulation based on a variety of different factors. For example, such factors may include, but are not limited to, where the client data 121 is stored (e.g., by the data custodian), where the principal is a citizen and/or resident, a type of the client data 121, local/federal regulations of one or more geographic locations, other characteristics associated with the data custodian, other characteristics associated with the principal, other characteristics associated with the client data 121, etc.

In an embodiment, the geographic privacy posture may represent an indication as to whether the client data 121 is or may potentially be susceptible/vulnerable to risk, e.g., privacy risk, based on one or more of the factors. If the client data is or may potentially be susceptible/vulnerable to privacy risk, the geographic privacy posture may also indicate or quantify, based on the one or more factors, a level of the privacy risk. Based on the determined geographic privacy posture, the one or more embodiments described herein may determine one or more protective custodial measures that can be implemented such that privacy protection of the client data 121 improves as will be described in further detail below.

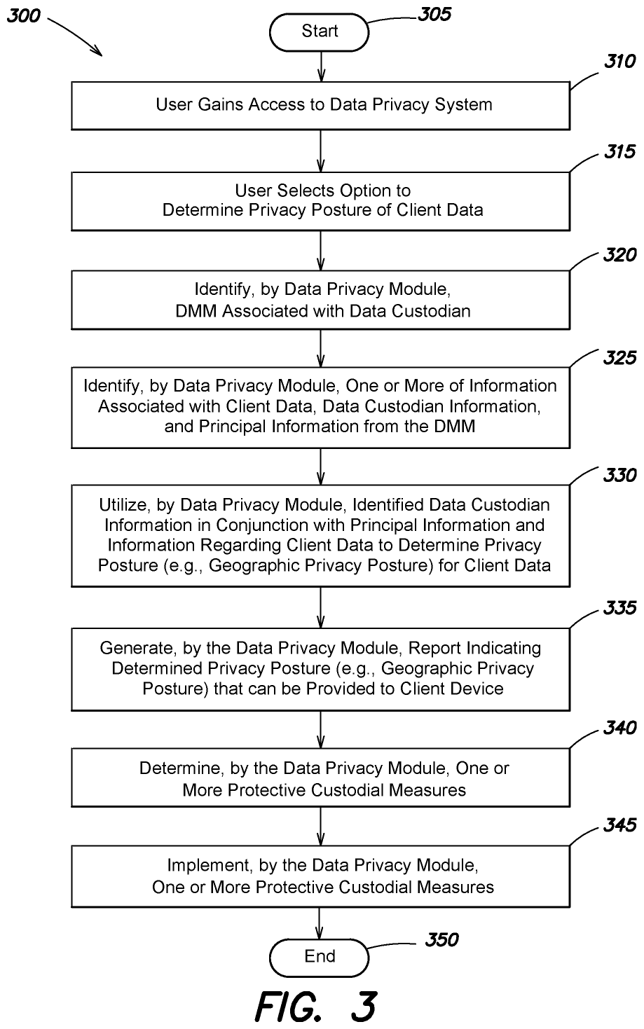

FIG. 3 is a schematic illustration of a flow diagram of an example method for determining a geographic privacy posture for the client data 121 such that one or more protective custodial measures can be implemented according to one or more embodiments described herein. The procedure 300 starts at step 305 and continues to step 310 where a user gains access to the data privacy system 125. In an embodiment, the user is an individual who is a data custodian of client data 121, or the user is an individual who is associated with an entity that is the data custodian (e.g., a corporate officer, employee, etc. of the entity that is the data custodian) of the client data 121. As such, and with reference to FIG. 2, the user is to be understood as a data custodian of client data 121.

The user may log into the data privacy system 125, stored on the one or more cloud-based devices 120, utilizing the client device 110 and providing user credentials (e.g., username and password). Specifically, the user may first establish a unique account with the data privacy system 125. More specifically, the user may utilize client device 110 to access, via intelligent gateway 116, one or more user interfaces (UIs), such as webpages, and then utilize the client-facing UIs to provide identifiable information (e.g., name, name of corporation, date of birth, address, and/or Social Security number, etc.) to the data privacy system 125. The data privacy system 125 may utilize the personal information to establish a unique system account for the user (e.g., register the individual or entity that is the data custodian with the data privacy system 125). Subsequently, the user may provide user credentials (e.g., username and password) to the data privacy system 125, and the data privacy system 125 may provide the user with access to a unique data privacy account. As such, the data privacy system 125 may then provide the user with access to the features and functions of the data privacy system 125, e.g., determine a geographic privacy posture for the client data 121.

Referring back to FIG. 3, once the user accesses the data privacy system 125, the procedure continues to step 315 and the user may select an option to determine a privacy posture of the client data 121. For example, the user may select a link, button, tab, etc. on a website associated with the data privacy system. In addition, or alternatively, the user may select the option to determine a privacy posture of the client data using a command line interface or some other function, graphical affordance, input command, etc.

The procedure continues to step 320 and the data privacy module 118 identifies the DMM 129 associated with the data custodian (i.e., user). For example, the data privacy module 118 may utilize the user credentials, that are unique to the user, to identify the DMM 129 associated with the data custodian. Specifically, and as explained above, there may be a different stored DMM 129 for each of a plurality of different data custodian. As such, data privacy module 118 may identify a particular DMM 129 of the plurality of DMMs 129 utilizing the user credentials. Continuing with the hospital example, the unique user credentials (e.g., username) may be utilized to identify a DMM 129 the is associated with the hospital that stores, for example, patient medical records.

The procedure then continues to step 325 and the data privacy module 118 identifies, from the DMM 129, the information associated with the client data 121, data custodian information, and principal information.

Continuing with the example of the hospital, the data privacy module 118 may identify information on DMM 129 that indicates that John Doe, who resides in Boston, Mass. and is a citizen of the United States, is a principal for the medical records of the client data 121 stored in Massachusetts by the hospital that is the data custodian. Additionally, the data privacy module 118 may also identify Jane Does, who resides in San Francisco, Calif. and is a citizen of Germany, as the principal for the medical records of the client data 121 stored in California by the hospital that is the data custodian.

The procedure continues to step 330 and the data privacy module 118 utilizes the identified data custodian information in conjunction with the principal data and information regarding client data 121 (e.g., type of client data) to determine privacy posture (e.g., a geographic privacy posture) for the client data 121 stored by the data custodian. Continuing with the hospital example, the data privacy module 118 may determine that because John Doe is a citizen of the United States and the client data 121 related to John Doe is stored in Massachusetts, John Doe's patient medical records are governed or should be governed by Health Insurance Portability and Accountability Act (HIPAA) and local privacy rules/regulations of Massachusetts. The data privacy module 118 may also determine that because Jane Doe is a citizen of Germany, and even though the hospital is a U.S. based provider, Jane Doe's patient medical records are governed or should be governed by General Data Protection Regulations (GDPR) for the European Union, i.e., not governed by HIPAA. Additionally, the data privacy module 118 may also determine that Jane's medical records are governed by local privacy rules/regulations of California since Jane's medical records are stored in California.

Therefore, and according to the one or more embodiments described herein, the data privacy module 118 can utilize the principal information stored in DMM 129 for the data custodian to determine what right are provided for the principal of the client data 121, and the data privacy module 118 can also utilize the data custodian information stored in the DMM 129 to determine what privacy rules/regulations are applicable to the client data 121. In an embodiment, the rules/regulations and guidelines associated with a governance (e.g., HIPAA, GDPR, etc.) may be accessed by the data privacy module 118 over the network from one or more sources (not shown).

Thus, the data privacy module 118 can, utilizing the data model (e.g., the DMM 129 that may be dynamic), intelligently determine (i.e., identify) the rights and/or regulations that are applicable to the client data 121 based on a variety of different factors that may be associated with the client data 121 itself (e.g., type), assigned labels to the client data 121, the data custodian information, and principal information as described above. Although the example described herein utilizes a particular type of client data (e.g., medical records), particular data custodian information, and particular principal information, it is expressly contemplated that the one or more embodiment described herein may determine (i.e., identify) rights and/or regulations utilizing different types of client data, different data custodian information, different principal information, and/or different factors (e.g., data sovereignty). As such, the example as describe herein with reference to the hospital is for illustrative purposes only.

The data privacy module 118 may also determine a current privacy implementation utilized for client data 121 based on, for example, the data custodian information. Continuing with the hospital example, the hospital utilizes a single level encryption for the medical records stored in Massachusetts and California. The data privacy module 118 may compare the current privacy implementation with the identified right and/or rules/regulations to determine the geographic privacy posture for the client data 121. Specifically, the data privacy module 118 may determine if the single level encryption implemented for John Doe's medical records complies and/or satisfies HIPAA and also complies and/or satisfies the privacy rules/regulations of Massachusetts. Additionally, the data privacy module 118 may determine if the single level encryption implemented for Jane Doe's medical records complies and/or satisfies GDPR and also complies and/or satisfies the privacy rules/regulation of California.

In this example, let it be assumed that the single level encryption for John's medical records complies/satisfies HIPAA and the privacy rules/regulations of Massachusetts, and the single level of encryption for Jane's medical records does not comply/satisfy the GDPR and the privacy rules/regulations of California.

Thus, and in this example, the determined geographic privacy posture for John Doe's medical records may be “compliant” while the geographical privacy posture for Jane Doe's medical records may be “non-compliant”. Because Jane's medical records are non-complaint, the data privacy module 118 may determine a level of non-compliance, for example. For example, the data privacy module 118 may utilize a number and type of determined protective custodial measures that are required for compliance to determine or quantify the non-compliance. For example, a fewer number and/or types of protective custodial measures that are easily implementable may be indicative of a “low-level” of non-compliance. Conversely, a larger number and/or types of protective custodial measure that are difficult to implement may be indicative of “high-level” of non-compliance.

In an embodiment, a data protection policy may be utilized in conjunction with the DMM to determine the geographical privacy posture for the client data 121. For example, let it be assumed that Jane Doe moves from San Francisco, Calif. to Boise, Id. In addition, let it be assumed that the hospital defines a data protection policy, e.g., a user signs into the hospital user account and utilized a computing device to define the data protection policy for the hospital with the data privacy system 125, that indicates that any medical records in California that are determined to be “non-compliant” should be ignored/overridden if the principal related to the medical record is not currently domiciled in California. Therefore, and int his example, the data privacy module 118 may override the “non-compliant” condition for Jane Doe's medical records based on the defined data protection policy. As such, the data privacy module 118 may, based on the defined data protection policy, either change the geographical privacy posture for Jane Doe's medical record to “compliant” or either ignore the “non-compliant” condition such that the data custodian is not informed of the “non-complaint” condition. Therefore, an entity, e.g., a hospital, can utilize the data protection policy as described herein to customize the manner in which the data privacy module 118 determine the privacy posture based on different attributes, specifications, and/or characteristics that are of interest to the entity. Additionally, the policy may be exported from the data privacy system 125 to an external source (not shown) for periodic review or backup. In an implementation, the policy may be utilized as a secure ledger of policy changes and an audit log when, for example, traceability is required. The secure ledger may be stored as blockchain entries or other secure distributed method.

In addition or alternatively, the data privacy module 118 may monetarily quantify non-compliance. For example, the data privacy module 118 may calculate the monetary penalties for not complying with the privacy rules/regulations required based on the data custodian information and/or principal information. The monetary penalties may, for example, be based on current rules/regulations and/or future rules/regulations.

The procedure, optionally, continues to step 335 and the data privacy module 118 may generate a report indicating the determined privacy posture (e.g., geographic privacy posture) and provide the report to the client device 110 via the network. For example, the report may indicate the determined geographic privacy posture. In addition or alternatively, the report may be a pictorial representation (e.g., map) that illustrates the determined geographic privacy posture. For example, the data privacy module 118 may generate a map that includes a marking with a graphical affordance (e.g., color, shading, etc.) on Massachusetts that is indicative of compliance. Additionally, the data privacy module 118 may include a marking with a different graphical affordance on California that is indicative of non-compliance. In an embodiment, and when the data protection policy is utilized as described above, the marking on California may be with graphical affordance that is indicative of compliance since the data protection policy overrides the determined non-compliant condition.

The generated report may be provided, via intelligent gateway 116, to the client device 110 such that the user can evaluate and understand the determined privacy posture. For example, and when the report is the map, the user may interact with the report by selecting a marking on Massachusetts to obtain further information about the determined privacy posture. Specifically, the user may select (e.g., “drill down”) the marking on Massachusetts to learn of how the client data 121 is compliant with the rights and/or rules/regulations based on the data custodian information and the principal information. The user may also select the marking on California to learn of how the client data 121 is not compliant with the rights and/or rules/regulations based on the data custodian information and the principal information. Based on the selection, the report may, for example, provide which rights and/or rules/regulations that have not been satisfied and/or indicate the monetary penalties.

Additionally, the data privacy module 118 may determine one or more protective custodial measures that can be taken by the data custodian such that the geographical privacy posture changes from being non-complaint to compliant. Referring back to FIG. 3, and after the geographic privacy posture for the client data is determined, the procedure continues to step 340 and the data privacy module 118 determines one or more custodial measures to improve the privacy posture of the client data 121. For example, the data privacy module 118 may determine that the one or more protective custodial measure that are required for compliance include, but are not limited to, utilizing one or more data obfuscation techniques (e.g., dual-level encryption), moving the client data to a different location, etc. Thus, in this example and because Jane's medical records are non-compliant, the data privacy module 118 may determine one or more custodial measure that can be taken for Jane's medical record to move the privacy posture from non-compliance to compliance.

In an embodiment, the one or more protective custodial measure may be directed to future compliance (e.g., not current compliance). For example, the data privacy module 118 may determine/identify a rule/regulation that is to take effect in the future. As such, and based on the comparison of the privacy position of the client data 121 with the future rules/regulations, the data privacy module 118 may determine what protective custodial measure should be taken such that the client data 121 is compliant in the future.

The procedure continues to step 345 and, optionally, the data privacy module 118 implements one or more protective custodial measures to improve the graphical privacy posture of the client data. For example, the data privacy module 118 may, through the intelligent gateway 116, establish a secure tunnel to the client data 116. The data privacy module 118 may then implement the one or more protective custodial measures such that rules/regulations are satisfied. For example, the data privacy module 118 may obfuscate the client data 121 such that it is client data cannot be associated with a particular individual, e.g., the client data 121 is scrambled to prevent unauthorized access to Jane Doe's patient medical records. In response to implementing the one or more protective custodial measures for client data 121, the data privacy module 118 may update the DMM 129 of the data custodian to reflect the implementations. As such, the DMM 129 provides an accurate and an up-to-date (e.g., real-time or near real-time) representation regarding the privacy posture of the client data 121. The procedure then ends at step 350.

In addition to being responsible for client data 121, a data custodian may have one or more affiliates (e.g., vendors, contractors, etc.). Continuing with the hospital example, the hospital may be affiliated with a plurality of different Doctors who have private practices that are located in one or more different locations with different patients, e.g., principals. The affiliates may be governed by different rules/regulations and may the custodian for different principals that have different rights. Accordingly, the data custodian, e.g., a hospital, may be interested in knowing if their affiliates are adhering to the rules/regulations that are applicable to the data custodian and its management of client data 121.

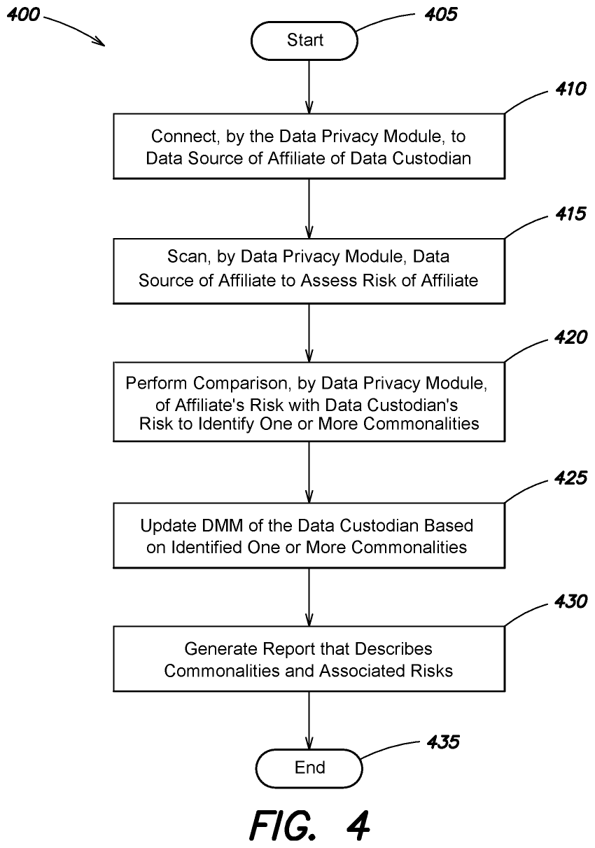

FIG. 4 is a schematic illustration of a flow diagram of an example method for determining an affiliate risk for an affiliate of a data custodian according to one or more embodiments described herein. The procedure 400 starts at step 405 and continues to step 410 and the data privacy module 118 connects to a data source (e.g., website, data store, etc.) of an affiliate of a data custodian. For example, the data privacy module 118 may connect to the data source via the intelligent gateway 116. Continuing with the example where the hospital is the data custodian, let it be assumed that an affiliate of the hospital is Dr. X who has a private practice that is located in Worcester, Mass.

The procedure continues to step 415 and the data privacy module 118 performs a scan of the data source of the affiliate to assess the risk (e.g., privacy risk) of the affiliate. For example, the data privacy module 118 may perform a scan of the data source of the affiliate in a similar manner as described above with reference to FIG. 2. Additionally, and as described above with reference to FIG. 2, a data structure, e.g., heat map, may similarly be generated for the affiliate's risk.

The procedure continues to step 420 and the data privacy module 118 may perform a comparison of the affiliate's risk with the data custodian's risk to identify one or more commonalities. Specifically, the respective data structures (e.g., heat maps or tables) that capture respective risks for the affiliate and the data custodian may be compared to identify the one or more commonalities, e.g., a union set. For example, the commonalities may include, but are not limited to, the same type of data, one or more same regulations/laws/governances that are to be adhered to, etc. According to the one or more embodiments described herein, the affiliate's risk can be defined as a “singularity” as a record, but may when combined with other data from the organization, can be generated as a map of relative risk of fine, regulatory sanction or for reporting.

The procedure continues to step 425 and the data privacy module 118 updates the DMM 129 of the data custodian based on the identified one or more commonalities. For example, the DMM 129 for the data custodian may be updated with a label for the affiliate and corresponding information that describes the risk. As such, the DMM 129 for the data custodian also includes the relevant risks for its affiliates that are of concern and in common with the data custodian. Thus, and when the geographic privacy posture is determined as described with reference to FIG. 3, the common privacy risk for the data custodian's affiliates can be considered for the data custodian.

The procedure optionally continues to step 430 and the data privacy module generates a report that describes the one or more commonalities and their associated risks (e.g., privacy risks) that can be provided to data custodian. For example, the generated report may be a heat map. The report may, in an implementation, be provided over the network 111 to the client device 110 of the data custodian. The procedure then ends at step 435.

Accordingly, and by determining a privacy posture for client data 121, the one or more embodiments described herein provide an improvement in the technological field, i.e., technology, of electronic data privacy and security. Additionally, and because the data privacy module 118 can implement one or more protective custodial measures to improve the privacy/security of the client data 121, the one or more embodiments described herein provide an improvement to a computer itself. That is, because the privacy/security of the client data 121 is improved, the stored client data 121 (e.g., stored on storage architecture 122) is less susceptible to being accessed by unauthorized individuals and/or being used for unauthorized purposes. Accordingly, the privacy of the computer associated with the storage architecture is approved according to the one or more embodiments described herein.

The foregoing description of embodiments is intended to provide illustration and description, but is not intended to be exhaustive or to limit the disclosure to the precise form disclosed. Modifications and variations are possible in light of the above teachings or may be acquired from a practice of the disclosure. For example, while a series of acts has been described above with respect to the flow diagrams, the order of the acts may be modified in other implementations. In addition, the acts, operations, and steps may be performed by additional or other modules or entities, which may be combined or separated to form other modules or entities. Further, non-dependent acts may be performed in parallel. Also, the term “user”, as used herein, is intended to be broadly interpreted to include, for example, a computer or data processing system or a human user of a computer or data processing system, unless otherwise stated.

Further, certain embodiments described herein may be implemented as logic that performs one or more functions. This logic may be hardware-based, software-based, or a combination of hardware-based and software-based. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description has been directed to specific embodiments of the present disclosure. It will be apparent, however, that other variations and modifications may be made to the described embodiments, with the attainment of some or all of their advantages. Therefore, it is the object of the appended claims to cover all such variations and modifications as come within the true spirit and scope of the disclosure.

What is claimed is:

1. A system, comprising:
a processor configured to execute a data privacy module, the data privacy module configured to:
scan one or more data sources for electronic client data, wherein a data custodian is responsible for at least one of a privacy or a security of the electronic client data, and wherein the electronic client data is related to a principal;
extract, classify, and label the electronic data based on one or more data characteristics associated with the electronic client data, wherein the electronic client data is protected from unauthorized use utilizing one or more privacy algorithms or the client data is not protected from the unauthorized use utilizing the one or more privacy algorithms;
update a data management model of the data custodian based on the one or more data characteristics, wherein the data management model further includes data custodian information associated with the data custodian and principal information associated with the principal; and
determine a privacy posture for the electronic client data utilizing the data management model or the data management model and the one or more privacy algorithms when the electronic client data is protected.

2. The system of claim 1, wherein the data privacy module is configured to:
determine, based on a privacy posture, one or more protective custodial measures to improve the privacy posture of the client data; and
automatically implement the one or more protective custodial measures to improve the privacy posture of the client data.

3. The system of claim 1, wherein the privacy posture is based on at least a data custodian geography of the data custodian and a principal geography of the principal.

4. The system of claim 1, wherein the electronic client data is extracted utilizing natural language processing and the electronic client data is classified and labeled utilizing one or more artificial intelligence neural network.

5. The system of claim 1, wherein the data privacy module is further configured to:
generate a report based on the classification and labeling of the electronic client data, wherein the report provides an indicate or metric representing an associated risk for one or more portions of the electronic client data.

6. The system of claim 5, wherein the report provides at least one of a severity score or monetary indication wherein the monetary indication indicates one or potential monetary penalties associated with the one or more portions of the electronic client data that is related to the metric representing the associated risk, and wherein severity score indicates a privacy risk associated the one or more portions of the electronic client data, where the severity score may be based on a scale where a first end of the scale indicates low privacy risk while a second end of the scale indicates high privacy risk.

7. The system of claim 1, wherein a particular label assigned to the electronic client data is utilized to determine one or more protective custodial measures to improve the privacy posture.

8. The system of claim 1, wherein the data privacy module is further configured to:
receive input commands that define a data protection policy for the data custodian; and
determine the privacy posture for the electronic client data utilizing the data management model and the data protection policy or the data management model, the data protection policy, and the one or more privacy algorithms when the electronic client data is protected.

9. A method, comprising:
scanning, by a processor, one or more data sources for electronic client data, wherein a data custodian is responsible for at least one of a privacy or a security of the electronic client data, and wherein the electronic client data is related to a principal;
extracting, classifying, and labeling the electronic data, by the processor, based on one or more data characteristics associated with the electronic client data, wherein the electronic client data is protected from unauthorized use utilizing one or more privacy algorithms or the client data is not protected from the unauthorized use utilizing the one or more privacy algorithms;
updating a data management model of the data custodian based on the one or more data characteristics, wherein the data management model further includes data custodian information associated with the data custodian and principal information associated with the principal; and
determining a privacy posture for the electronic client data utilizing the data management model or the data management model and the one or more privacy algorithms when the electronic client data is protected.

10. The method of claim 9, further comprising:
determining, based on a privacy posture, one or more protective custodial measures to improve the privacy posture of the client data; and
automatically implementing the one or more protective custodial measures to improve the privacy posture of the client data.

11. The method of claim 9, wherein the privacy posture is based on at least a data custodian geography of the data custodian and a principal geography of the principal.

12. The method of claim 9, wherein the electronic client data is extracted utilizing natural language processing and the electronic client data is classified and labeled utilizing one or more artificial intelligence neural network.

13. The method of claim 9, further comprising:
generating a report based on the classification and labeling of the electronic client data, wherein the report provides an indicate or metric representing an associated risk for one or more portions of the electronic client data.

14. The method of claim 13, wherein the report provides at least one of a severity score or monetary indication wherein the monetary indication indicates one or potential monetary penalties associated with the one or more portions of the electronic client data that is related to the metric representing the associated risk, and wherein severity score indicates a privacy risk associated the one or more portions of the electronic client data, where the severity score may be based on a scale where a first end of the scale indicates low privacy risk while a second end of the scale indicates high privacy risk.

15. The method of claim 9, wherein a particular label assigned to the electronic client data is utilized to determine one or more protective custodial measures to improve the privacy posture.

16. The method of claim 9, further comprising:
receiving input commands that define a data protection policy for the data custodian; and
determining the privacy posture for the electronic client data utilizing the data management model and the data protection policy or the data management model, the data protection policy, and the one or more privacy algorithms when the electronic client data is protected.

17. A non-transitory computer readable medium having software encoded thereon, the software when executed by one or more computing devices operable to:
scan one or more data sources for electronic client data, wherein a data custodian is responsible for at least one of a privacy or a security of the electronic client data, and wherein the electronic client data is related to a principal;
extract, classify, and label the electronic data based on one or more data characteristics associated with the electronic client data, wherein the electronic client data is protected from unauthorized use utilizing one or more privacy algorithms or the client data is not protected from the unauthorized use utilizing the one or more privacy algorithms;
update a data management model of the data custodian based on the one or more data characteristics, wherein the data management model further includes data custodian information associated with the data custodian and principal information associated with the principal; and
determine a privacy posture for the electronic client data utilizing the data management model or the data management model and the one or more privacy algorithms when the electronic client data is protected.

18. The non-transitory computer readable medium of claim 17, the one or more computing devices operable to:
determine, based on a privacy posture, one or more protective custodial measures to improve the privacy posture of the client data; and
automatically implement the one or more protective custodial measures to improve the privacy posture of the client data.

19. The non-transitory computer readable medium of claim 17, wherein the privacy posture is based on at least a data custodian geography of the data custodian and a principal geography of the principal.

20. The non-transitory computer readable medium of claim 17, wherein the electronic client data is extracted utilizing natural language processing and the electronic client data is classified and labeled utilizing one or more artificial intelligence neural network.
